(19) United States
(12) Patent Application Publication
(10) Pub. No.: US 2007/0046643 A1
(43) Pub. Date: Mar. 1, 2007

(54) State-Based Approach to Gesture Identification

(76) Inventors: W. Daniel Hillis, Encino, CA (US); James L. Benson, Cypress, CA (US); James Lamanna, Pasadena, CA (US)

Correspondence Address: GLENN PATENT GROUP, 3475 EDISON WAY, SUITE L, MENLO PARK, CA, 94025, US

(21) Appl. No.: 11/458,956

(22) Filed: Jul. 20, 2006

Related U.S. Application Data
(63) Continuation-in-part of application No. 10/913,105, filed on Aug. 6, 2004.
(60) Provisional application No. 60/701,892, filed on Jul. 22, 2005.

(51) Int. Cl. G09G 5/00

(52) U.S. Cl. 345/173

(57) ABSTRACT

A method and apparatus for identifying user gesture includes a touch sensor for determining contact information that describes locations at which a user contacts a touch sensitive surface corresponding to a display. The touch sensor provides the contact information to a gesture identification module which uses state information to identify a user gesture and, responsive thereto issues an associated display command to a display control module. The display control module updates the display based on display commands received from the gesture identification module.

### RELATED APPLICATIONS

This application is related to U.S. utility patent application Ser. No. 10/913,105 entitled “Touch Detecting Interactive Display”, attorney docket number APPL0053, filed Aug. 6, 2003, and U.S. provisional patent application Ser. No. 60/647,343 entitled “Touch Table Touch Detection and Gesture Recognition Technologies”, attorney docket number APPL0058PR, filed Jan. 25, 2005, and U.S. provisional patent application Ser. No. 60/701,892 entitled “Interactive Display Technologies”, attorney docket number APPL0065PR, filed Jul. 22, 2005, which applications are incorporated herein in their entirety by this reference thereto.

### BACKGROUND

1. Technical Field

The invention relates to interactive displays. More particularly, the invention relates to touch detecting, multi-user, interactive displays.

2. Description of the Prior Art

There are many situations in which one or more individuals interactively explore image based data. For example, a team of paleontologists may wish to discuss an excavation plan for a remote dig site.

To do so, they wish to explore in detail the geographic characteristics of the site as represented on digitized maps. In most laboratories, this would require the team to either huddle around a single workstation and view maps and images on a small display, or sit at separate workstations and converse by telephone.

One approach to addressing this shortcoming is a touch detecting interactive display, such as that disclosed in the referenced patent filing “Touch Detecting Interactive Display.” In such a system, an image is produced on a touch detecting display surface. The locations at which a user contacts the surface are, determined and, based on the position of the motions of these locations, user gestures are determined. The display is then updated based on the determined user gestures.

FIG. 1 shows several users operating an exemplary touch detecting interactive display. The users 50 surround the display 100 such that each can view the display surface 150, which shows imagery of interest to the users. For example, the display may present Geographic Information System (GIS) imagery characterized by geographic 161, economic 162, political 163, and other features, organized into one or more imagery layers. Because the users can comfortably surround and view the display, group discussions and interaction with the display is readily facilitated.

Corresponding with the display surface is a touch sensor 155 that is capable of detecting when and where a user touches the display surface. Based upon the contact information provided by the touch sensor user gestures are identified and a command associated with the user gesture is determined. The command is executed, altering the displayed imagery in the manner requested by the user via the gesture. For example, in FIG. 1, a user 55 gestures by placing his fingertips on the display surface and moving them in an outwardly separating manner.

Many touch sensors used n displays, such as that shows in FIG. 1, such as the Smart Board from Smart Technologies of Calgary, Canada, provide the coordinates of one or more detected contacts.

Typically, the contact information is updated over time at discrete intervals, and based upon the motion of the contact locations, user gestures are identified. Determining gestures from the contact information alone, however, provides considerable challenge. Gesture Identification schemes often fail to correctly address imperfections in
Simultaneity. For example, consider a user intending to initiate two contacts simultaneously and perform a single, coordinated gesture involving the two contacts. Invariably, a slight temporal separation is present between the time the first contact is initiated and the time the second contact is initiated. Based on this separation, many gesture identification schemes erroneously determine that the contacts are associated with two distinct gestures.
Singularity. For example, consider a user intending to initiate and drag a single contact. The user initiates the contact with a single extended finger inclined at an angle to the touch sensor and drags the finger to one side.

However, during the dragging motion, the user inadvertently decreases the inclination of his finger, and the user3 s knuckles initiate a second contact. As the second contact is separated both temporally and spatially from the initial contact, many gesture identification schemes erroneously determine that the second contact is associated with a new and distinct gesture.
Stillness. For example, consider a user intending to designate an object with a single stationary, short duration contact. Inadvertently, the user moves the contact slightly between initiation and termination. Based on this motion, many gesture identification schemes erroneously determine that the motion is a dragging gesture.

In each of these cases, the gesture identification scheme has failed in that the intent of the user is not faithfully discerned.

Systems addressing the above deficiencies have been proposed. For example, in U.S. Pat. No. 5,543,591 to Gillespie et al a touch sensor provides, on a provisional basis, all motions of a detected contact to a host computer, to be interpreted as cursor movements. If, however, the contact is terminated within a short period of time after initiation of the contact and the distance moved since initiation of the contact is small, the cursor motions are reversed and the contact is interpreted as a mouse click. However, while this approach may be suitable for control of a cursor, it is not suitable for control of imagery, where undoing motions may lead to significant user confusion. Thus, despite such improvements, it would be advantageous to provide a more reliable method of classifying user gestures from contact information that more accurately discerns the intent of a user in performing the gesture.

### SUMMARY OF THE INVENTION

A method and apparatus for identifying user gesture includes a touch sensor for determining contact information that describes locations at which a user contacts a touch sensitive surface corresponding to a display. The touch sensor provides the contact information to a gesture identification module which uses state information to identify a user gesture and, responsive thereto issues an associated display command to a display control module. The display control module updates the display based on display commands received from the gesture identification module.

### BRIEF DESCRIPTION OF THE DRAWINGS

FIG. 1 shows several users operating an exemplary touch detecting interactive display;

FIG. 2 shows a flow chart summarizing the state-based gesture identification;

FIG. 3 shows a schematic representation of the gesture identification module behavior; and

FIG. 4 shows the classification of contact motion as aligned or opposed.

### DETAILED DESCRIPTION

To address the above noted deficiencies, a novel state-based approach to identifying user gestures is proposed. Gestures are identified in a manner that more accurately reflects user intent, thereby facilitating more natural interaction with the display.

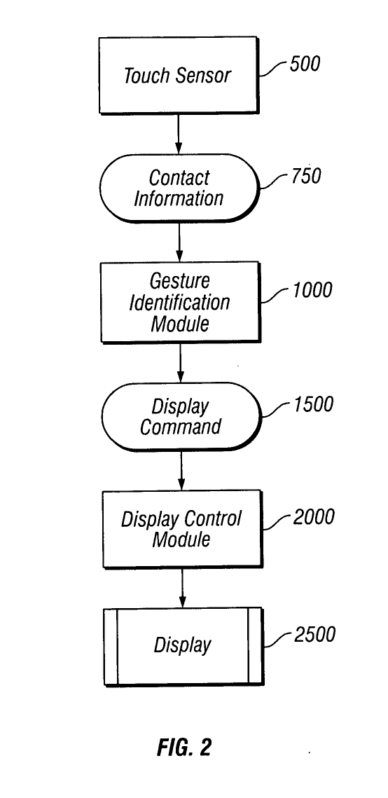

FIG. 2 shows a flow chart summarizing the state-based gesture identification. A touch sensor 500 determines contact information describing the locations at which a user contacts the touch sensitive surface corresponding to the display. The touch sensor provides the contact information 750 to a gesture identification module 1000. The gesture identification module identifies a user gesture, and issues an associated display command 1500 to a display control module 2000. The display control module updates the display 2500 based on the display command received from the gesture identification module.

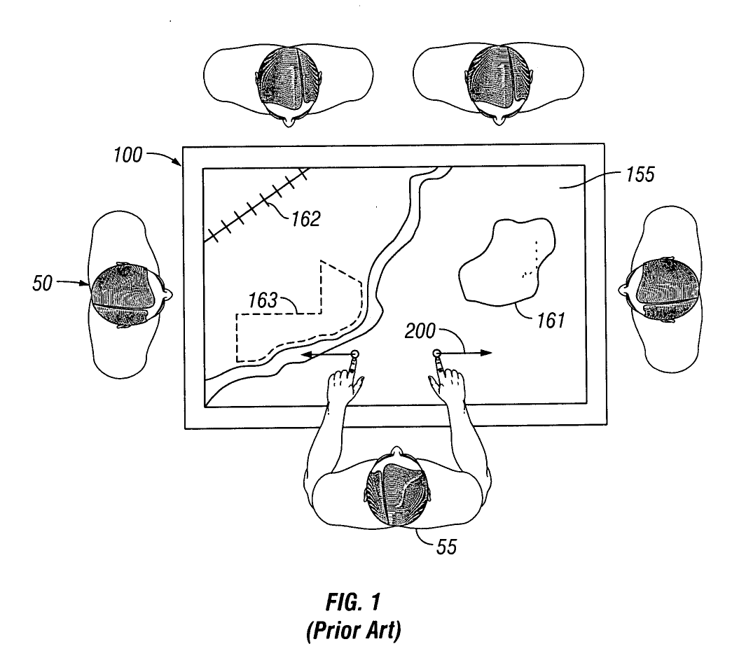

In the preferred embodiment of the invention the touch sensor is physically coincident with the display, as shown in FIG. 1. This may be achieved, for example, by projecting imagery onto a horizontal touch sensor with an overhead projector. However, in alternative embodiments of the invention, the touch sensor and display are physically separate.

The touch sensor of FIG. 2 may determine contact information using any one of a number of different approaches. In the preferred embodiment of the invention, a set of infrared emitters and receivers is arrayed around the perimeter of the projection surface, oriented such that each emitter emits light in a plane a short distance above the projection surface. The location where the user is touching the projection surface is determined by considering which emitters are and are not occluded, as viewed from each of the receivers. A configuration incorporating a substantially continuous set of emitters around the perimeter and three receivers, each positioned in a corner of the projection surface, is particularly effective in resolving multiple locations of contact.

Alternatively, a resistive touch pad, such as those commonly used in laptop computers, may be placed beneath a flexible display surface. The resistive touch pad comprises two layers of plastic that are separated by a compressible insulator, such as air, with a voltage differential maintained across the separated layers. When the upper layer is touched with sufficient pressure, it is deflected until it contacts the lower layer, changing the resistive characteristics of the upper to lower layer current pathway. By considering these changes in resistive characteristics, the location of the contact can be determined. Capacitive touch pads may also be used, such as the Synaptics TouchPad™ (www.synaptics.com/products/touchpad.cfm).

As shown in FIG. 2, contact information is provided from the touch sensor to the gesture identification module. Typically, the contact information is updated over time at discrete, regular intervals. In the preferred embodiment of the invention, the touch sensor provides contact information for up to two contacts at each update, and the gesture identification module identifies gestures based on the initiation, termination, position, and motion of the up to two contacts. For touch sensors providing information for more than two contacts, the gesture identification module may simply ignore additional contacts initiated when two current contacts are presently reported by the touch sensor.

Preferably, the touch sensor explicitly indicates within the contact information that a contact has been initiated or terminated. Alternatively, the gesture identification module may infer an initiation or termination of a contact from the inception, continuation, and ceasing of position information for a particular contact. Similarly, some touch sensors may explicitly report the motion of a contact point within the contact information. Alternatively, the gesture identification module may store the contact information reported by the touch sensor at successive updates. By comparing the position for each contact point over two or more updates, motion may be detected. More specifically, a simple difference between two consecutive updates may be computed, or a more complicated difference scheme incorporating several consecutive updates, e.g. a moving average, may be used. The later approach may be desirable contact positions reported by touch sensor exhibit a high level of noise. In this case, a motion threshold may also be employed, below which motion is not detected.

Herein, the first and second contact are referred to as C1 and C2. The initiation of the first contact, as either reported by the sensor or determined by the gesture identification module, is referred to as D1 (“Down-1”), and the initiation of a second contact is referred to as D2. Similarly, the termination of the first and second contact is referred to as U1 (“Up-1”) and U2, respectively. The presence of motion of the first and second contacts is termed M1 and M2, respectively. More specifically, M1 and M2 are computed as the difference between the position of C1 and C2 at the current update and the position of C1 and C2 at the previous update.

Often, a user may briefly lose contact with the touch sensor, or the touch sensor itself may briefly fail to register a persistent contact. In either case, the software monitoring the contact information registers the termination of one contact and the initiation of a new contact, despite the fact that the user very likely considers the action as a continued motion of a single contact. Thus, in some embodiments of the invention, a smoothing capability may be added to address intermittent loss of contact. Specifically, a minimum time may be required before a termination of a contact is acknowledged. That is, if the touch sensor reports that position information is no longer available for contact C1 or C2, and then shortly thereafter reports a new contact in the immediate vicinity, the new contact may be considered a continuation of the prior contact. Appropriate thresholds of time and distance may be used to ascertain if the new contact is, in fact, merely a continuation of the previous contact.

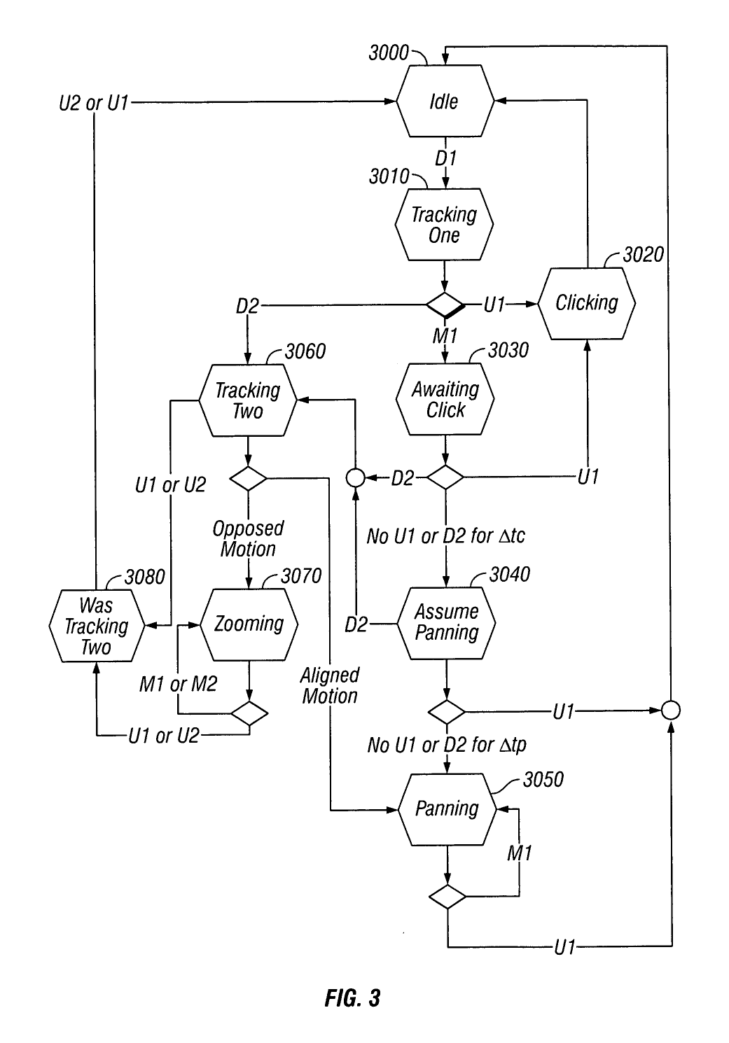

FIG. 3 shows a schematic representation of the gesture identification module behavior. The behavior of the gesture identification module is best considered as a series of transitions between a set of possible states. Upon receipt of updated contact information from the touch sensor, the gesture identification module determines, based on the initiation, termination, and motion of the contacts, whether it transitions into another state or remains in the current state. Depending on the current state, the gesture identification module may also identify a user gesture and send an appropriate display command to the display control module.

Upon initialization, the gesture identification module enters the Idle state (3000). In the Idle state, the gesture identification module identifies no gesture and issues no display command to the display control module. The gesture identification module remains in the Idle state until the initiation D1 of a first contact C1. Upon initiation D1 of a first contact C1, the gesture identification module enters the Tracking One state (3010).

In the Tracking One state, the gesture identification module identifies no gesture and issues no display command to the display control module. However, the gesture identification module continues to monitor the contact C1. If the first contact is terminated U1, the gesture identification module enters the Clicking state (3020). If motion M1 of the first contact is detected, the gesture identification module enters the Awaiting Click state (3030). If the initiation of a second contact D2 is detected, the gesture identification module enters the Tracking Two state (3060). Otherwise, the gesture identification module remains in the Tracking One state.

In the Awaiting Click state, the gesture identification module identifies no gesture and issues no display command to the display control module. However, the gesture identification module continues to monitor the behavior of the first contact and awaits a possible second contact. If the first contact is terminated U1 within a predetermined time period 66 t_{c}, the gesture identification module enters the Clicking state. If a second contact is initiated D2 within the predetermined time period Δt_{c}, the gesture identification module enters the Tracking Two state. If the first contact is not terminated and a second contact is not initiated within the predetermined time period Δt_{c}, the gesture identification module enters the Assume Panning state (3040).

In the Clicking state, the gesture identification module identifies a clicking gesture and issues a click command to the display control module, that, when executed by the display control module, provides a visual confirmation that a location or object on the display has been designated.

In the Assume Panning state, the gesture identification module identifies no gesture and issues no display command to the display control module. However, the gesture identification module continues to monitor the behavior of the first contact and awaits a possible second contact. If the first contact is terminated U1 within a predetermined time period Δtₚ, the gesture identification module returns to the Idle state. If a second contact is initiated D2 within the predetermined time period Δtₚ, the gesture identification module enters the Tracking Two state. If the first contact is not terminated, and a second contact is not initiated within the predetermined time period Δtₚ, the gesture identification module determines that neither a click nor a gesture requiring two contacts is forthcoming and enters the Panning state (3050).

In the Panning state, the gesture identification module identifies a panning gesture and issues a pan command to the display control module that, when executed by the display control module, translates the displayed imagery. Generally, the pan command specifies that the imagery be translated a distance proportional to the distance the first contact has moved M1 between the previous and current updates of the first contact position C1. Preferably, the translation of the imagery, measured in pixels, is equal to the movement of the first contact, measured in pixels. This one-to-one correspondence provides the user with a natural sense of sliding the imagery as if fixed to the moving contact location. If the first contact is terminated U1, the gesture identification module returns to the Idle state. If the first contact continues to move M1, the gesture identification module remains in the Panning state to identify another panning gesture and issue another pan command to the display control module. Panning thus continues until one of the contacts is terminated.

In the Tracking Two state, the gesture identification module identifies no gesture and issues no display command to the display control module. However, the gesture identification module continues to monitor the behavior of the first and second contacts. If either the first or second contact is terminated, U1 or U2, the gesture identification module enters the Was Tracking Two state. Otherwise, the gesture identification module determines if the motions of the first and second contact points M1 and M2 are aligned or opposed. If the contact points exhibit Opposed Motion, the gesture identification module enters the Zooming state (3070). If the contact points exhibit Aligned Motion, the gesture identification module enters the Panning state. Aligned Motion thus results in two contacts being treated as one in that the behavior of the second contact is ignored in the Panning state. This greatly alleviates the problems encountered when a user attempts to gestures with his entire hand. As noted previously, a user often believes he is contacting the touch sensor at a single, hand sized region but, in fact, establishes two separate contact points as determined by the touch sensor.

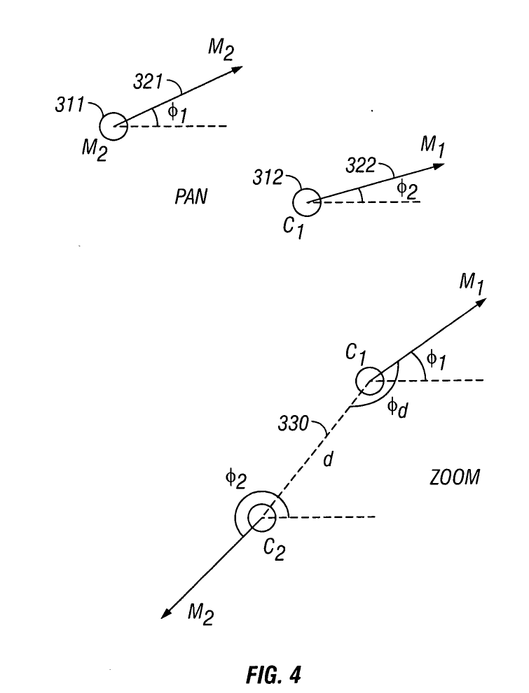

FIG. 4 shows the classification of contact motion as aligned or opposed. Before the distinction between Opposed Motion and Aligned Motion can be determined, motion of both contacts, M1 and M2, must be present. The motions M1 and M2 are considered aligned if the angle between the motion vectors 321 and 322 is less than a predetermined angular threshold. This calculation is preferably performed by considering the angle of the motion vectors relative to a common reference, such as a horizontal, as shown in FIG. 4 by the angles (φ1 and (φ2. The angle between the two motion vectors is the absolute value of the difference between the angles, and the motions are considered aligned if
|φ₁−φ₂|<θₐ (1)

Similarly, the motions are considered opposed if
|φ₁−φ₂|>θₒ (2)

In the preferred embodiment of the invention, θₐ=θₒ, That is, any pair of motions M1 and M2 is classified as either aligned or opposed. In this instance, only one of the two tests described in Equations 1 and 2 need be performed. If the test for aligned motion is performed and the criterion is not satisfied, the motions are considered opposed. Conversely, if the test for opposed motion is performed and the criterion is not satisfied, the motions are considered aligned.

In an alternative embodiment of the invention, θₐ≠θₒ, providing an angular region of dead space (θₐ≧φ≦θₒ) within which the motions are neither aligned nor opposed. In this embodiment, both tests described in Equations 1 and 2 must be performed. If neither criterion is satisfied, the gesture identification module remains in the Tracking Two state.

In the Zooming state, the gesture identification module identifies a zooming gesture and issues a zoom command to the display control module that, when executed by the display control module, alters the magnification of the displayed imagery. Specifically, with each update of contact information, the magnification of the screen is scaled by the factor

$$K = \frac{d}{{d}_{o}} \qquad ( 3 )$$

where dₒ is the distance between C1 and C2 prior to the most recent update, and d is the distance 330 between C1 and C2 after the most recent update If either the first or second contact is terminated, U1 or U2, the gesture identification module enters the Was Tracking Two state (FIG. 3; 3040). If either or both of the first and second contact continue to move, M1 or M2, the gesture identification module remains in the Zooming state to identify another zooming gesture and issue another zoom command to the display control module. Zooming thus continues until the first contact is terminated.

In the Was Tracking Two state, the gesture identification module identifies no gesture and issues no display command to the display control module. The gesture identification module awaits the termination of the remaining contact, U2 or U1. Upon termination of the remaining contact, the gesture identification module returns to the Idle state.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method for identifying user gestures, comprising the steps of:
a touch sensor determining contact information that describes locations at which a user contacts a touch sensitive surface corresponding to a display;
said touch sensor providing said contact information to a gesture identification module;
said gesture identification module using state information to identify a user gesture and, responsive thereto, issuing an associated display command to a display control module; and
said display control module updating said display based on display commands received from said gesture identification module.

2. The method of claim 1, wherein said touch sensor is physically coincident with said display.

3. The method of claim 1, wherein said touch sensor and said display are physically separate.

4. The method of claim 1, said touch sensor determining contact information using a set of infrared emitters and receivers arrayed around a perimeter of a projection surface, oriented such that each emitter emits light in a plane that is a predetermined distance above said projection surface, wherein a location where a user is touching said projection surface is determined by considering which emitters are and are not occluded as viewed from each of said receivers.

5. The method of claim 1, said touch sensor incorporating a substantially continuous set of emitters around a perimeter and three receivers, each positioned in a corner of a projection surface.

6. The method of claim 1, said touch sensor incorporating a resistive touch pad placed beneath a flexible display surface, said resistive touch pad comprising at least two layers of plastic that are separated by a compressible insulator, with a voltage differential maintained across said separated layers; wherein when an upper layer is touched with sufficient pressure, it is deflected until it contacts a lower layer, changing a resistive characteristics of an upper to lower layer current pathway; wherein from said changes in resistive characteristics a location of contact is determined.

7. The method of claim 1, said touch sensor incorporating a capacitive touch pad.

8. The method of claim 1, further comprising the step of:
providing contact information from said touch sensor to said gesture identification module; wherein said contact information is updated over time at discrete, regular intervals.

9. The method of claim 1, further comprising the steps of:
providing contact information from said touch sensor for up to two contacts at each update; and
said gesture identification module identifying gestures based on initiation, termination, position, and motion of said up to two contacts.

10. The method of claim 9, wherein for touch sensors providing information for more than two contacts, said gesture identification module ignoring additional contacts initiated when two current contacts are presently reported by said touch sensor.

11. The method of claim 1, further comprising the step of:
said touch sensor explicitly indicating within contact information that a contact has been initiated or terminated.

12. The method of claim 1, further comprising the step of:
said gesture identification module inferring an initiation or termination of a contact from inception, continuation, and ceasing of position information for a particular contact.

13. The method of claim 1, wherein said touch sensor explicitly reports motion of a contact point within contact information.

14. The method of claim 1, wherein said gesture identification module stores contact information reported by said touch sensor at successive updates.

15. The method of claim 1, further comprising the step of:
comparing a position for each contact point over two or more updates to detect motion.

16. The method of claim 15, further comprising the step of:
computing a difference between at least two consecutive updates.

17. The method of claim 15, further comprising the step of:
computing a motion threshold below which motion is not detected.

18. The method of claim 1, further comprising the step of:
adding a smoothing capability to address intermittent loss of contact.

19. The method of claim 18, wherein a minimum time is required before a termination of a contact is acknowledged; wherein if said touch sensor reports that position information is no longer available for a contact and then shortly thereafter reports a new contact in an immediate vicinity, a new contact is considered a continuation of a prior contact.

20. The method of claim 1, wherein said gesture identification module operates as a series of transitions between a set of possible states; wherein upon receipt of updated contact information from said touch sensor, said gesture identification module determines, based on initiation, termination, and motion of said contacts, whether it transitions into another state or remains in a current state; wherein depending on a current state, said gesture identification module also identifies a user gesture and sends an appropriate display command to said display control module.

21. The method of claim 20, wherein upon initialization, said gesture identification module enters an idle state; wherein in said idle state, said gesture identification module identifies no gesture and issues no display command to said display control module; wherein said gesture identification module remains in said idle state until initiation of a first contact.

22. The method of claim 21, wherein upon initiation of a first contact, said gesture identification module enters a tracking one state; wherein in said tracking one state, said gesture identification module identifies no gesture and issues no display command to said display control module; wherein said gesture identification module continues to monitor said first contact.

23. The method of claim 22, wherein if said first contact is terminated, said gesture identification module enters a clicking state.

24. The method of claim 23, wherein if motion of said first contact is detected, said gesture identification module enters an awaiting click state.

25. The method of claim 24, wherein if initiation of a second contact is detected, said gesture identification module enters a tracking two state.

26. The method of claim 25, wherein in an awaiting click state, said gesture identification module identifies no gesture and issues no display command to said display control module; wherein said gesture identification module continues to monitor behavior of said first contact and awaits a possible second contact.

27. The method of claim 26, wherein if a first contact is terminated within a predetermined time period, said gesture identification module enters a clicking state.

28. The method of claim 27, wherein if a second contact is initiated within a predetermined time period, said gesture identification module enters a tracking two state.

29. The method of claim 28, wherein if a first contact is not terminated and a second contact is not initiated within a predetermined time period, said gesture identification module enters an assume panning state.

30. The method of claim 29, wherein in a clicking state, said gesture identification module identifies a clicking gesture and issues a click command to said display control module that, when executed by said display control module, provides a visual confirmation that a location or object on said display has been designated.

31. The method of claim 30, wherein in an assume panning state, said gesture identification module identifies no gesture and issues no display command to said display control module; wherein said gesture identification module continues to monitor behavior of said first contact and awaits a possible second contact.

32. The method of claim 31, wherein if said first contact is terminated within a predetermined time period, said gesture identification module returns to an idle state.

33. The method of claim 32, wherein if a second contact is initiated within a predetermined time period, said gesture identification module enters a tracking two state.

34. The method of claim 33, wherein if said first contact is not terminated and a second contact is not initiated within a predetermined time period, said gesture identification module determines that neither a click nor a gesture requiring two contacts is forthcoming and enters a panning state.

35. The method of claim 34, wherein in a panning state, said gesture identification module identifies a panning gesture and issues a pan command to said display control module that, when executed by said display control module, translates displayed imagery; wherein said pan command specifies that imagery be translated a distance proportional to a distance said first contact has moved between previous and current updates of said first contact position.

36. The method of claim 35, wherein if said first contact is terminated, said gesture identification module returns to an idle state.

37. The method of claim 36, wherein if said first contact continues to move, said gesture identification module remains in a panning state to identify another panning gesture and issues another pan command to said display control module; wherein panning continues until one of said contacts is terminated.

38. The method of claim 37, wherein in a tracking two state, said gesture identification module identifies no gesture and issues no display command to said display control module; wherein said gesture identification module continues to monitor behavior of said first and second contacts; wherein if either said first or second contact is terminated, said gesture identification module enters a tracking two state.

39. The method of claim 38, wherein, otherwise, said gesture identification module determines if motions of said first and second contact points are aligned or opposed.

40. The method of claim 39, wherein if said contact points exhibit opposed motion, said gesture identification module enters a zooming state; wherein if said contact points exhibit aligned motion, said gesture identification module enters a panning state; wherein aligned motion results in two contacts being treated as one in that behavior of said second contact is ignored in said panning state.

41. The method of claim 20, wherein contact motion is classified as aligned or opposed; wherein before a distinction between opposed motion and aligned motion can be determined, motion of two contacts must be present; wherein said motions are considered aligned if an angle between two motion vectors is less than a predetermined angular threshold.

42. The method of claim 40, wherein in a zooming state, said gesture identification module identifies a zooming gesture and issues a zoom command to said display control module that, when executed by said display control module, alters magnification of displayed imagery; wherein with each update of contact information, magnification of a screen is scaled by a scale factor.

43. The method of claim 42, wherein if either a first or second contact is terminated, said gesture identification module enters a was tracking two state.

44. The method of claim 43, wherein if either or both of said first and second contact continue to move, said gesture identification module remains in a zooming state to identify another zooming gesture and issue another zoom command to said display control module; wherein zooming thus continues until said first contact is terminated.

45. The method of claim 44, wherein in said was tracking two state, said gesture identification module identifies no gesture and issues no display command to said display control module; wherein said gesture identification module awaits termination of a remaining contact; wherein upon termination of said remaining contact, said gesture identification module returns to an idle state.

46. An apparatus for identifying user gestures, comprising:
a touch sensor for determining contact information that describes locations at which a user contacts a touch sensitive surface corresponding to a display;
a gesture identification module for receiving said contact information from said touch sensor; and
a display control module for receiving an associated display command from said gesture identification module, said gesture identification module using state information to identify a user gesture and, responsive thereto, issuing said associated display command to said display control module;
wherein said display control module updates said display based on display commands received from said gesture identification module.

47. The apparatus of claim 46, wherein said touch sensor is physically coincident with said display.

48. The apparatus of claim 46, wherein said touch sensor and said display are physically separate.

49. The apparatus of claim 46, said touch sensor comprising:
means for determining contact information using a set of infrared emitters and receivers arrayed around a perimeter of a projection surface, oriented such that each emitter emits light in a plane that is a predetermined distance above said projection surface, wherein a location where a user is touching said projection surface is determined by considering which emitters are and are not occluded as viewed from each of said receivers.

50. The apparatus of claim 46, said touch sensor comprising a substantially continuous set of emitters around a perimeter and three receivers, each positioned in a corner of a projection surface.

51. The apparatus of claim 46, said touch sensor comprising a resistive touch pad placed beneath a flexible display surface, said resistive touch pad comprising at least two layers of plastic that are separated by a compressible insulator, with a voltage differential maintained across said separated layers; wherein when an upper layer is touched with sufficient pressure, it is deflected until it contacts a lower layer, changing a resistive characteristics of an upper to lower layer current pathway; wherein from said changes in resistive characteristics a location of contact is determined.

52. The apparatus of claim 46, said touch sensor comprising a capacitive touch pad.

53. The apparatus of claim 46, said touch sensor providing contact information for up to two contacts; and said gesture identification module identifying gestures based on initiation, termination, position, and motion of up to two contacts.

54. The apparatus of claim 46, said touch sensors providing information for more than two contacts, said gesture identification module ignoring additional contacts initiated when two current contacts are presently reported by said touch sensor.

55. The apparatus of claim 46, said touch sensor explicitly indicating within contact information that a contact has been initiated or terminated.

56. The apparatus of claim 46, said gesture identification module inferring an initiation or termination of a contact from inception, continuation, and ceasing of position information for a particular contact.

57. The apparatus of claim 46, further comprising:
means for comparing a position for each contact point over two or more updates to detect motion.

58. The apparatus of claim 46, further comprising:
means for computing a difference between at least two consecutive updates.

59. The apparatus of claim 46, further comprising:
means for computing a motion threshold below which motion is not detected.

60. The apparatus of claim 46, wherein said gesture identification module operates as a series of transitions between a set of possible states; wherein upon receipt of updated contact information from said touch sensor, said gesture identification module determines, based on initiation, termination, and motion of said contacts, whether it transitions into another state or remains in a current state; wherein depending on a current state, said gesture identification module also identifies a user gesture and sends an appropriate display command to said display control module.
